(19) United States
(12) Patent Application Publication
(10) Pub. No.: US 2024/0349247 A1
(43) Pub. Date: Oct. 17, 2024

(54) INFORMATION TRANSMISSION METHOD AND APPARATUS, INFORMATION TRANSMISSION INDICATION METHOD AND APPARATUS, AND TERMINAL

(71) Applicant: VIVO MOBILE COMMUNICATION CO., LTD., Dongguan (CN)

(72) Inventors: Huan WANG, Dongguan (CN); Zichao JI, Dongguan (CN); Shuyan PENG, Dongguan (CN)

(73) Assignee: VIVO MOBILE COMMUNICATION CO., LTD., Dongguan (CN)

(21) Appl. No.: 18/751,023

(22) Filed: Jun. 21, 2024

Related U.S. Application Data
(63) Continuation of application No. PCT/CN2022/141059, filed on Dec. 22, 2022.

(30) Foreign Application Priority Data
Dec. 23, 2021 (CN) 202111593230.X

(51) Int. Cl. H04W 72/02; H04L 1/08; H04L 1/1812; H04W 72/25; H04W 92/18

(52) U.S. Cl. CPC H04W 72/02; H04L 1/08; H04L 1/1812; H04W 72/25; H04W 92/18

(57) ABSTRACT

An information transmission method, a terminal, and a non-transitory computer-readable storage medium are provided. The information transmission method includes: transmitting, by a first terminal, request information or coordination information for one or more times. The request information is used to request a second terminal to feed back the coordination information, and the coordination information is used to provide sidelink resource selection information for the second terminal.

### CROSS-REFERENCE TO RELATED APPLICATIONS

This application is a continuation of International Application No. PCT/CN2022/141059, filed on Dec. 22, 2022, which claims priority to Chinese Patent Application No. 202111593230.X filed in China on Dec. 23, 2021. The entire contents of each of the above-referenced applications are expressly incorporated herein by reference.

### TECHNICAL FIELD

This application pertains to the field of communications technologies, and in particular, to an information transmission method and apparatus, an information transmission indication method and apparatus, and a terminal.

### BACKGROUND

In the New Radio (NR) SideLink (SL) technology, there are two ways to allocate resources, one is based on base station scheduling (mode 1), and the other is based on autonomous resource selection of the terminal. As for the resource allocation mode based on base station scheduling, a sidelink resource used by the terminal for data transmission is determined by the base station, and Transmit (TX) User Equipment (UE) is notified through downlink signaling for the resource allocation mode based on autonomous selection. The terminal selects an available transmission resource from a (pre-) configured resource pool, and before resource selection, the terminal performs channel sensing, selects a resource set with less interference based on a channel sensing result, and then randomly selects a resource for transmission from the resource set.

However, at present, an enhancement scheme for the resource allocation mode is proposed, in which the terminal selects the sidelink transmission resource based on resource information provided by a peer terminal. In this way, how to realize the enhancement scheme of this resource allocation mode has become an urgent technical problem that needs to be resolved.

### SUMMARY

Embodiments of this application provide an information transmission method and apparatus, an information transmission indication method and apparatus, and a terminal, which can realize the enhancement scheme of the resource allocation mode.

According to a first aspect, an information transmission method is provided, and the method includes:
transmitting, by a first terminal, request information and/or coordination information for one or more times, where
the request information is used to request a second terminal to feed back the coordination information, and the coordination information is used to provide sidelink resource selection information for the second terminal.

According to a second aspect, an information transmission apparatus is provided, including:
a first sending module, configured to transmit request information and/or coordination information for one or more times, where
the request information is used to request a second terminal to feed back the coordination information, and the coordination information is used to provide sidelink resource selection information for the second terminal.

According to a third aspect, an information transmission method is provided, including:
receiving, by a second terminal, request information and/or coordination information transmitted for one or more times, where
the request information is used to request the second terminal to feed back the coordination information, and the coordination information is used to provide sidelink resource selection information for the second terminal.

According to a fourth aspect, an information transmission apparatus is provided, including:
a first receiving module, configured to receive request information and/or coordination information transmitted for one or more times, where
the request information is used to request a second terminal to feed back the coordination information, and the coordination information is used to provide sidelink resource selection information for the second terminal.

According to a fifth aspect, an information transmission indication method is provided, including:
sending, by a third terminal, 1st stage Sidelink Control Information (SCI) and/or 2nd stage SCI, where
the 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

According to a sixth aspect, an information transmission indication apparatus is provided, including:
a second sending module, configured to send 1st stage SCI and/or 2nd stage SCI, where
the 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

According to a seventh aspect, an information transmission indication method is provided, including:
receiving, by a fourth terminal, 1st stage SCI and/or 2nd stage SCI, where
the 2nd stage SCI is used to transmit request information and/or coordination information, the request information is used to request the fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

According to an eighth aspect, an information transmission indication apparatus is provided, including:
a second receiving module, configured to receive 1st stage SCI and/or 2nd stage SCI, where
the 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

According to a ninth aspect, a terminal is provided. The terminal includes a processor and a memory, the memory stores a program or an instruction that can be run on the processor, and the program or the instruction is executed by the processor to implement steps of the method according to the first aspect, the third aspect, the fifth aspect, or the seventh aspect.

According to a tenth aspect, a terminal is provided. The terminal includes a processor and a communications interface. The communications interface is configured to implement steps of the method according to the first aspect, the third aspect, the fifth aspect, or the seventh aspect.

According to an eleventh aspect, a communications system is provided. The communications system includes a terminal and a network side device. The terminal can be configured to implement steps of the method according to the first aspect, the third aspect, the fifth aspect, or the seventh aspect.

According to a twelfth aspect, a readable storage medium is provided. The readable storage medium stores a program or an instruction, where when the program or the instruction is executed by a processor, steps of the method according to the first aspect, the third aspect, the fifth aspect, or the seventh aspect are implemented.

According to a thirteenth aspect, a chip is provided. The chip includes a processor and a communications interface, the communications interface is coupled to the processor, and the processor is configured to run a program or an instruction, to implement steps of the method according to the first aspect, the third aspect, the fifth aspect, or the seventh aspect.

According to a fourteenth aspect, a computer program/program product is provided. The computer program/program product is stored in a storage medium, and the computer program/program product is executed by at least one processor, to implement steps of the method according to the first aspect, the third aspect, the fifth aspect, or the seventh aspect.

In the embodiments of this application, the first terminal sends the request information to the second terminal one or more times, requesting the second terminal to feed back the coordination information, so that the first terminal can learn of the SL resource selection information provided by the second terminal for the first terminal and perform resource selection based on the SL resource selection information. After receiving the request information sent by the second terminal, the first terminal can also provide SL resource selection information for the second terminal by feeding back the coordination information to the second terminal for one or more times, so that the second terminal can perform resource selection based on the SL resource selection information. In this way, through information transmission between the first terminal and the second terminal, an enhancement scheme for the resource allocation mode is realized.

### BRIEF DESCRIPTION OF DRAWINGS

FIG. 1 is a block diagram of a wireless communications system according to an embodiment of this application;

FIG. 2 is a schematic flowchart of an information transmission method at a first terminal side according to an embodiment of this application;

FIG. 3 is a schematic flowchart of an information transmission method at a second terminal side according to an embodiment of this application;

FIG. 4 is a schematic flowchart of an information transmission method at a third terminal side according to an embodiment of this application;

FIG. 5 is a schematic flowchart of an information transmission method at a fourth terminal side according to an embodiment of this application;

FIG. 6 is a schematic diagram of a structure of an apparatus module corresponding to FIG. 2;

FIG. 7 is a schematic diagram of a structure of an apparatus module corresponding to FIG. 3;

FIG. 8 is a schematic diagram of a structure of an apparatus module corresponding to FIG. 4;

FIG. 9 is a schematic diagram of a structure of an apparatus module corresponding to FIG. 5;

FIG. 10 is a schematic diagram of a structure of a communications device according to an embodiment of this application; and

FIG. 11 is a schematic diagram of a structure of a terminal according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. An NR system is described in the following description for illustrative purposes, and the NR terminology is used in most of the following description, although these technologies can also be applied to applications other than the NR system application, such as the 6^{th} Generation (6G) communications system.

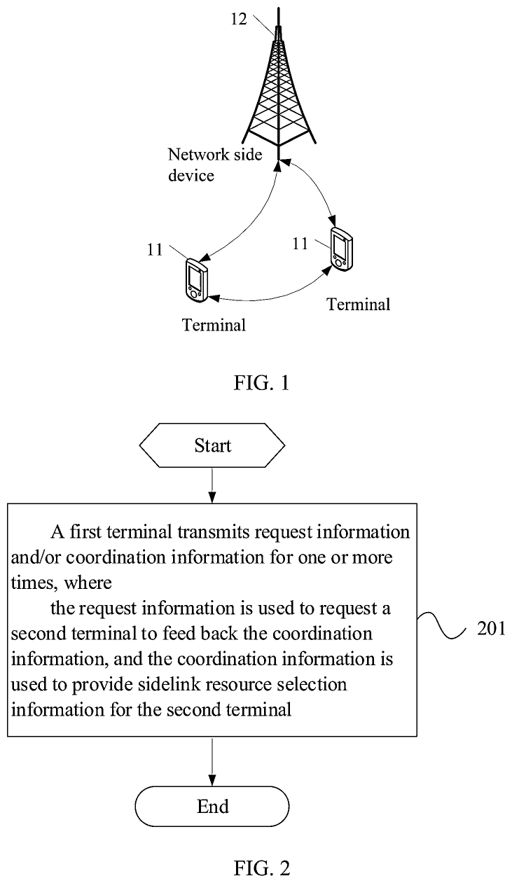

FIG. 1 is a block diagram of a wireless communication system to which the embodiments of this application may be applied. The wireless communication system includes terminals 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a Wearable Device (WD), Vehicle User Equipment (VUE), Pedestrian User Equipment (PUE), smart household (household devices with wireless communications functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access node, a Wi-Fi node, or the like. The base station may be referred to as a NodeB, an evolved NodeB (eNB), an access point, a (Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

The following describes in detail the information transmission method and apparatus, the information transmission indication method and apparatus, and the terminal provided in the embodiments of this application through some embodiments and application scenarios thereof with reference to the accompanying drawings.

As shown in FIG. 2, an embodiment of this application provides an information transmission method, including the following steps.

Step 201. A first terminal transmits request information and/or coordination information for one or more times.

The request information is used to request a second terminal to feed back the coordination information, and the coordination information is used to provide sidelink resource selection information for the second terminal.

In this way, through the step 201, the first terminal sends the request information to the second terminal one or more times, requesting the second terminal to feed back the coordination information, so that the first terminal can learn of the SL resource selection information provided by the second terminal for the first terminal and perform resource selection based on the SL resource selection information. After receiving the request information sent by the second terminal, the first terminal can also provide SL resource selection information for the second terminal by feeding back the coordination information to the second terminal for one or more times, so that the second terminal can perform resource selection based on the SL resource selection information. In this way, through information transmission between the first terminal and the second terminal, an enhancement scheme for the resource allocation mode is realized.

The request information and/or the coordination information is carried by 2nd stage SCI or Media Access Control Control Element (MAC CE). The coordination information provides SL resource selection information for the second terminal by carrying the SL resource selection information or indicating the SL resource selection information.

In some embodiments, step 201 includes:
transmitting, by the first terminal, the request information and/or the coordination information for one or more times based on a preset number of retransmissions.

Herein, the preset number of retransmissions is configured or predefined. Based on the preset number of retransmissions, the first terminal only transmits the request information and/or the coordination information once when the preset number of retransmissions is 0; and when the preset number of retransmissions is greater than 0, the preset number of retransmissions of the request information and/or the coordination information is performed. In this way, excessive signaling overhead caused by the excessive number of retransmissions of the request information and/or the coordination information can be avoided. In addition, the preset number of retransmissions configured or predefined can also be understood as a configured or predefined maximum number of retransmissions, and an actual number of retransmissions is less than or equal to the maximum number of retransmissions.

Certainly, in a case that a plurality of preset numbers of retransmissions are configured or predefined, the first terminal transmits the request information and/or the coordination information for more than one time with a maximum present number of retransmissions.

In addition, the number of transmissions or the maximum number of transmissions can be configured or predefined, and the number of transmissions or the maximum number of transmissions minus one is the preset number of retransmissions or the maximum number of retransmissions. In addition, the number of transmissions or the maximum number of transmissions can be separately configured or predefined for transmission of the request information and/or the coordination information, so as to ensure that the system can flexibly control resource costs of transmission of the request information and/or the coordination information.

In addition, in this embodiment, in a manner, transmission of the request information and/or the coordination information supports retransmission that is based on Hybrid Automatic Repeat reQuest ACKnowledgement (HARQ-ACK). Therefore, before step 201, the method further includes:
determining, by the first terminal based on received first HARQ-ACK information or second HARQ-ACK information, whether to retransmit the request information and/or the coordination information, where
the first HARQ-ACK information is generated by the second terminal based on whether 2nd stage SCI is successfully demodulated, and the 2nd stage SCI carries the request information and/or the coordination information; and
the second HARQ-ACK information is generated by the second terminal based on whether an MAC PDU or a MAC layer data packet is successfully demodulated, and the MAC PDU or the MAC layer data packet includes an MAC CE carrying the request information and/or the coordination information.

In this way, after receiving the HARQ-ACK information or the second HARQ-ACK information, the first terminal can determine whether to retransmit the request information and/or the coordination information.

In some embodiments, the determining, by the first terminal based on the first HARQ-ACK information, whether to retransmit the request information and/or the coordination information includes:
in a case that the received first HARQ-ACK information is negative acknowledgement, retransmitting, by the first terminal, the request information and/or the coordination information; or
in a case that the first HARQ-ACK information is not received, retransmitting, by the first terminal, the request information and/or the coordination information; or
in a case that the received first HARQ-ACK information is acknowledgement, stopping transmitting, by the first terminal, the request information and/or the coordination information.

To be specific, if the first terminal determines, based on the first HARQ-ACK information, whether to retransmit the request information and/or the coordination information, it can be determined that in a case that the received first HARQ-ACK information is negative acknowledgement, the request information and/or the coordination information is retransmitted; in a case that the received first HARQ-ACK information is acknowledgement, the request information and/or the coordination information is stopped from being transmitted; and in a case that the first HARQ-ACK information is not received, the request information and/or the coordination information are/is retransmitted. Then the first terminal performs transmission based on the determined content.

In some embodiments, the determining, by the first terminal based on the second HARQ-ACK information, whether to retransmit the request information and/or the coordination information includes:
in a case that the received second HARQ-ACK information is negative acknowledgement, retransmitting, by the first terminal, the request information and/or the coordination information; or
in a case that the second HARQ-ACK information is not received, retransmitting, by the first terminal, the request information and/or the coordination information; or
in a case that the received second HARQ-ACK information is acknowledgement, stopping transmitting, by the first terminal, the request information and/or the coordination information.

To be specific, if the first terminal determines, based on the second HARQ-ACK information, whether to retransmit the request information and/or the coordination information, an implementation is determined as follows: the first terminal may retransmit the request information and/or the coordination information in a case that the received second HARQ-ACK information is negative acknowledgement; may stop transmitting the request information and/or the coordination information in a case that the received second HARQ-ACK information is acknowledgement; and may retransmit the request information and/or the coordination information in a case that the second HARQ-ACK information is not received. Then the first terminal performs transmission based on the determined content.

In some embodiments, the determining, by the first terminal based on the second HARQ-ACK information, whether to retransmit the request information and/or the coordination information includes:
in a case that the received second HARQ-ACK information is negative acknowledgement or acknowledgement, stopping transmitting, by the first terminal, the request information and/or the coordination information; or
in a case that the second HARQ-ACK information is not received, retransmitting, by the first terminal, the request information and/or the coordination information.

To be specific, if the first terminal determines, based on the second HARQ-ACK information, whether to retransmit the request information and/or the coordination information, another implementation is determined as follows: the first terminal may stop transmitting the request information and/or the coordination information in a case that the received second HARQ-ACK information is negative acknowledgement or acknowledgement (that is, as long as the second HARQ-ACK information is received, regardless of whether the second HARQ-ACK information is negative acknowledgement or acknowledgement); and may retransmit the request information and/or the coordination information in a case that the second HARQ-ACK information is not received. Then the first terminal performs transmission based on the determined content.

In this embodiment, the first HARQ-ACK information is generated by the second terminal based on whether 2nd stage SCI is successfully demodulated; and the second HARQ-ACK information is generated based on whether a MAC PDU or a MAC layer data packet is successfully demodulated.

If the second terminal obtains the request information and/or the coordination information by demodulating the 2nd stage SCI, the second terminal may generate the first HARQ-ACK information when the 2nd stage SCI is demodulated successfully (that is, the 2nd stage SCI is demodulated correctly), and in this case, the first HARQ-ACK information is acknowledgement (ACK). On the contrary, when the 2nd stage SCI is not successfully demodulated (failed), the first HARQ-ACK information is generated, and in this case, the first HARQ-ACK information is negative acknowledgement (NACK). Thus, when the first terminal determines, based on the first HARQ-ACK information, whether to retransmit the request information and/or the coordination information, if the first terminal receives the first HARQ-ACK information, and the first HARQ-ACK information is ACK, the first terminal may stop transmitting the request information and/or the coordination information; if the first terminal receives the first HARQ-ACK information, and the first HARQ-ACK information is NACK, the first terminal may retransmit the request information and/or the coordination information; and if the first terminal does not receive the first HARQ-ACK information, the first terminal may also retransmit the request information and/or the coordination information.

Certainly, whether the first HARQ-ACK information generated by the second terminal is ACK or NACK can also be determined based on whether the 2nd stage SCI is successfully demodulated, and whether the MAC PDU or the MAC layer data packet includes only the MAC CE carrying the request information and/or the coordination information. That is, in a case that the received MAC PDU or MAC layer data packet includes only the MAC CE, and the 2nd stage SCI is successfully demodulated, the generated first HARQ-ACK information is ACK; and in a case that the received MAC PDU or MAC layer data packet includes only the MAC CE, and the 2nd stage SCI is not successfully demodulated, the generated first HARQ-ACK information is NACK.

In addition, in this embodiment, the first terminal may determine, based on whether the MAC PDU or the MAC layer data packet includes information other than the MAC CE, whether the first terminal is based on the first HARQ-ACK information or the second HARQ-ACK information, to determine whether to retransmit the request information and/or the coordination information.

In some embodiments, the determining, by the first terminal based on received first HARQ-ACK information or second HARQ-ACK information, whether to retransmit the request information and/or the coordination information includes at least one of the following:
in a case that the MAC PDU or the MAC layer data packet includes only the MAC CE, determining, by the first terminal based on the first HARQ-ACK information, whether to retransmit the request information and/or the coordination information; and
in a case that the MAC PDU or the MAC layer data packet includes information other than the MAC CE, determining, by the first terminal based on the second HARQ-ACK information, whether to retransmit the request information and/or the coordination information.

In this way, if the MAC PDU or the MAC layer data packet includes only a MAC CE carrying the request information and/or the coordination information, the first terminal may determine, based on the first HARQ-ACK information, whether to retransmit the request information and/or the coordination information; and if the MAC PDU or the MAC layer data packet includes information other than the MAC CE carrying the request information and/or the coordination information, the first terminal may determine, based on the second HARQ-ACK information, whether to retransmit the request information and/or the coordination information.

The other information included in the MAC PDU or the MAC layer data packet may be other SideLink-Shared Channel (SL-SCH).

Certainly, in this case, the second terminal obtains the request information and/or the coordination information by demodulating the 2nd stage SCI.

That is, the second terminal obtains the request information and/or the coordination information by demodulating the 2nd stage SCI. If the MAC PDU or the MAC layer data packet includes only the MAC CE carrying the request information and/or the coordination information, as long as the 2nd stage SCI is successfully demodulated, and the first HARQ-ACK information generated and fed back by the second terminal is ACK, the first terminal stops transmitting the request information and/or the coordination information after receiving the first HARQ-ACK information; or if the 2nd stage SCI is demodulated unsuccessfully, and the first HARQ-ACK information generated and fed back by the second terminal is NACK, the first terminal retransmits the request information and/or the coordination information after receiving the first HARQ-ACK information; or no matter whether the 2nd stage SCI is demodulated successfully or not, the first terminal retransmits the request information and/or the coordination information when not receiving the first HARQ-ACK information.

In addition, the second terminal obtains the request information and/or the coordination information by demodulating the 2nd stage SCI. If the MAC PDU or the MAC layer data packet includes information other than the MAC CE carrying the request information and/or the coordination information, regardless of whether the 2nd stage SCI is demodulated successfully or not, the second terminal generates and feeds back the second HARQ-ACK information based on whether the MAC PDU or the MAC layer data packet is demodulated successfully or not, and the first terminal determines, based on the second HARQ-ACK information, whether to retransmit the request information and/or the coordination information.

For example, in this embodiment, before the determining, by the first terminal based on the second HARQ-ACK information, whether to retransmit the request information and/or the coordination information, the method further includes:
determining, by the first terminal, whether the MAC PDU or the MAC layer data packet includes information other than the MAC CE; and
the determining, by the first terminal based on the second HARQ-ACK information, whether to retransmit the request information and/or the coordination information includes:
in a case that the MAC PDU or the MAC layer data packet includes information other than the MAC CE, and the second HARQ-ACK information is negative acknowledgement, retransmitting, by the first terminal, the request information and/or the coordination information;
in a case that the MAC PDU or the MAC layer data packet includes information other than the MAC CE, and the second HARQ-ACK information is acknowledgement, stopping transmitting, by the first terminal, the request information and/or the coordination information; and
in a case that the MAC PDU or the MAC layer data packet includes only the MAC CE, and the second HARQ-ACK information is negative acknowledgement or acknowledgement, stopping transmitting, by the first terminal, the request information and/or the coordination information.

That is, the second terminal obtains the request information and/or the coordination information by demodulating the 2nd stage SCI. If the MAC PDU or the MAC layer data packet includes information other than the MAC CE carrying the request information and/or the coordination information, regardless of whether the 2nd stage SCI is demodulated successfully or not, the second HARQ-ACK information generated and fed back by the second terminal is ACK when the MAC PDU or the MAC layer data packet is demodulated successfully. Then the first terminal stops transmitting the request information and/or the coordination information after receiving the second HARQ-ACK information; or if the second HARQ-ACK information generated and fed back by the second terminal is NACK when the MAC PDU or the MAC layer data packet is demodulated unsuccessfully, the first terminal retransmits the request information and/or the coordination information after receiving the second HARQ-ACK information. If the MAC PDU or the MAC layer data packet includes only the MAC CE carrying the request information and/or the coordination information, regardless of whether the 2nd stage SCI is demodulated successfully or not, and regardless of whether the MAC PDU or the MAC layer data packet is demodulated successfully or not, the first terminal stops transmitting the request information and/or the coordination information when the received second HARQ-ACK information is negative acknowledgement or acknowledgement. In this case, no matter whether the second HARQ-ACK information is negative acknowledgement or acknowledgement, when the first terminal receives the second HARQ-ACK information, the first terminal will consider that the second terminal has correctly demodulated the 2nd stage SCI and obtained the request information and/or the coordination information.

Certainly, in a case that the second terminal obtains the request information and/or the coordination information by demodulating the 2nd stage SCI, and the received MAC PDU or MAC layer data packet includes information other than the MAC CE carrying the request information and/or the coordination information, the second HARQ-ACK information can be generated and sent by the second terminal based on whether the MAC PDU or the MAC layer data packet is demodulated successfully or not.

For example, in this embodiment, before step 201, the method further includes:
sending, by the first terminal, first information and/or receiving second information sent by the second terminal, where
the first information is used to indicate whether the first terminal obtains the request information and/or the coordination information by demodulating 2nd stage SCI; and the second information is used to indicate whether the second terminal obtains the request information and/or the coordination information by demodulating the 2nd stage SCI.

The first terminal and the second terminal can notify each other whether to obtain the request information and/or the coordination information by demodulating the 2nd stage SCI. Specifically, the first terminal and the second terminal can notify each other in the form of UE capability.

For example, in this embodiment, the transmitting, by a first terminal, request information and/or coordination information for more than one time includes:
retransmitting, by the first terminal, the request information and/or the coordination information in a preset manner, where
the preset manner includes at least one of the following:
blind retransmission; and
retransmission based on received first HARQ-ACK information or second HARQ-ACK information.

That is, the first terminal retransmits the request information and/or the coordination information by at least one of blind retransmission and retransmission based on the received first HARQ-ACK information or second HARQ-ACK information (HARQ based retransmission).

For blind retransmission, HARQ-ACK retransmission-related parameters do not need to be carried in the 2nd stage SCI/MAC CE that carries at least the request information/coordination information, to reduce signaling overhead. For blind retransmission and HARQ based retransmission, the dynamic balance between resource utilization and reliability can be achieved.

For example, in this embodiment, a first information field of the coordination information indicates resource selection information, where the resource selection information includes a target transmission resource that is preferred/non-preferred to be selected by the second terminal; and
a time-frequency resource indicated by the first information field or a time-domain resource in which the time-frequency resource indicated by the first information field is located is the target transmission resource that is preferred/non-preferred to be selected by the second terminal.

For the coordination information in the 2nd stage SCI/MAC CE, a first information field of the coordination information can be resource combination(s) and first resource location(s). The first information field indicates (directly or indirectly indicates) a target transmission resource that is preferred/non-preferred (preferred resource/non-preferred resource) to be selected by the second terminal. On the one hand, the time-frequency resource indicated by the first information field is the preferred resource/non-preferred resource; and on the other hand, the time-domain resource in which the time-frequency resource indicated by the first information field is located is the preferred resource/non-preferred resource.

Certainly, a specific indicator field other than the first information field is used to indicate at least one of the following situations, that is, the time-frequency resource indicated by the first information field is the target transmission resource that is preferred/non-preferred to be selected by the second terminal, or the time-domain resource in which the time-frequency resource indicated by the first information field is located is the target transmission resource that is preferred/non-preferred to be selected by the second terminal.

Two ways to interpret indication information in the first information field can distinguish the preferred resource/non-preferred resource generated based on a hidden node issue or an HD issue.

In addition, in this embodiment, the first terminal sends 1st stage SCI (1st stage SCI) and/or 2nd stage SCI; the 2nd stage SCI is used to transmit the request information and/or the coordination information; and the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the second terminal to provide a preferred resource selected by the first terminal;
the 2nd stage SCI is used to transmit the coordination information, and the coordination information is used to provide a preferred resource selected by the second terminal for the second terminal;
the 2nd stage SCI is used to transmit the request information, and the request information is used to request the second terminal to provide a non-preferred resource selected by the first terminal; and
the 2nd stage SCI is used to transmit the coordination information, and the coordination information is used to provide a non-preferred resource selected by the second terminal for the second terminal.

Certainly, the 1st stage SCI and/or the 2nd stage SCI can indicate that the 2nd stage SCI is used to transmit target information of the request information and/or the coordination information. The 2nd stage SCI is used to transmit the request information and/or the coordination information, the request information is used to request the second terminal to provide a preferred resource selected by the first terminal, and the coordination information is used to provide target information of a preferred resource selected by the second terminal for the second terminal. The 2nd stage SCI is used to transmit the request information and/or the coordination information, the request information is used to request the second terminal to provide a non-preferred resource selected by the first terminal, and the coordination information is used to provide target information of a non-preferred resource selected by the second terminal for the second terminal.

When obtaining the 1st stage SCI and/or the 2nd stage SCI, the second terminal can learn of the target information based on indication of the 1st stage SCI and/or the 2nd stage SCI, and adaptively demodulate the 2nd stage SCI for subsequent processing.

For example, in this embodiment, the 1st stage SCI indicates the target information through a reserved bit and/or a 2nd SCI format indicator field, and the 2nd stage SCI is associated with the 1st stage SCI.

For example, manner 1: the 2nd SCI format indicator field in the 1st SCI is used to indicate 2nd SCI format 2-C (namely, 2nd SCI used for transmitting the request information), 2nd SCI format 2-D (2nd SCI for transmitting the coordination information). ‘10’ indicates 2nd SCI format 2-C, ‘11’ indicates 2nd SCI format 2-D, and certainly, the reverse is also true.

Manner 2:2 bits of the reserved bits (such as 2 bits to 4 bits) in the 1st SCI are used to indicate the 2nd SCI format. If the reserved bits are greater than 2 bits, 2 bits are last 2 bits or first 2 bits in the reserved bits. All 0 reservation. ‘00’ indicates SCI that can be sent to a specific terminal for demodulation, ‘01’ indicates that 2nd SCI format can be used to transmit the request information, ‘10’ indicates that the 2nd SCI format can be used to transmit the coordination information, and ‘11’ indicates that the 2nd SCI format can be used to transmit the request information and the coordination information.

Manner 3:1 bit/2 code points in the 1st SCI indicates/indicate that 2nd SCI format is used for the preferred resource or non-preferred resource. One code point indicates that the 2nd SCI format is used for request information and/or coordination information associated with the preferred resource, and the other code point indicates that the 2nd SCI format is used for request information and/or coordination information associated with the non-preferred resource.

Certainly, in a case that only the 1st stage SCI indicates one or more pieces of the target information, any target information may be indicated by one code point, such as:
one code point indicates that the 2nd stage SCI is used to transmit the request information;
one code point indicates that the 2nd stage SCI is used to transmit the coordination information;
one code point indicates that the 2nd stage SCI is used to transmit the request information and/or the coordination information;
one code point indicates that the 2nd stage SCI is used to transmit the request information, and the request information is used to request the second terminal to provide a preferred resource selected by the first terminal;
one code point indicates that the 2nd stage SCI is used to transmit the coordination information, and the coordination information is used to provide a preferred resource selected by the second terminal for the second terminal;
one code point indicates that the 2nd stage SCI is used to transmit the request information and/or the coordination information, the request information is used to request the second terminal to provide a preferred resource selected by the first terminal, and the coordination information is used to provide a preferred resource selected by the second terminal for the second terminal;
one code point indicates that the 2nd stage SCI is used to transmit the request information, and the request information is used to request the second terminal to provide a non-preferred resource selected by the first terminal;
one code point indicates that the 2nd stage SCI is used to transmit the coordination information, and the coordination information is used to provide a non-preferred resource selected by the second terminal for the second terminal; and
one code point indicates that the 2nd stage SCI is used to transmit the request information and/or the coordination information, the request information is used to request the second terminal to provide a non-preferred resource selected by the first terminal, and the coordination information is used to provide a non-preferred resource selected by the second terminal for the second terminal.

Herein, if some bit(s) in reserved bits (for example, first N bits or last N bits) are used to determine 2nd SCI formats, other bit(s) can be used for other purposes.

For example, in this embodiment, in a case that 1st stage SCI and 2nd stage SCI jointly indicate the target information, the 1st stage SCI is associated with the 2nd stage SCI; and
the 1st stage SCI indicates that the 2nd stage SCI is used to transmit any one of the request information and the coordination information, and the 2nd stage SCI indicates the target information through at least one information field.

Herein, the at least one information field may be a specific indicator field dedicated to indicating the target information, or may be a non-specific indicator field of 2nd stage SCI such as resource combination(s) and/or first resource location(s). Certainly, for the non-specific indicator field, the target information can be indicated by special code points of the non-specific indicator field, for example, that the fixed code points in the resource combination(s) and/or the first resource location(s) are all 0 or all 1 indicates that the 2nd stage SCI is used to transmit the request information, and other code points indicate that the 2nd stage SCI is used to transmit the coordination information.

Specifically, that the 1st SCI and the 2nd SCI jointly indicate the target information includes the following manners.

Manner 1: the 2nd SCI format field in the 1st SCI is used to indicate 2nd SCI format 2-C, indicating that 2nd SCI format 2-C can be used to transmit request information and/or coordination information. First 2 bits of the 2nd SCI are used to indicate content carried in the 2nd SCI. For example, ‘00’ indicates that the 2nd SCI can be used to transmit request information, ‘01’ indicates that the 2nd SCI can be used to transmit coordination information, and ‘10’ indicates that 2nd SCI can be used to transmit request information and coordination information.

Manner 2: 1 bit/2 code points in the 1st SCI indicates that the 2nd SCI is used for preferred resource or non-preferred resource. For example, one code point indicates that the 2nd SCI is used to transmit request information and/or coordination information associated with the preferred resource, one code point indicates that the 2nd SCI is used to transmit request information and/or coordination information associated with a non-preferred resource. First 2 bits of the 2nd SCI indicate content carried in the 2nd SCI. For example, ‘00’ indicates that the 2nd SCI can be used to transmit request information, ‘01’ indicates that the 2nd SCI can be used to transmit coordination information, and ‘10’ indicates that 2nd SCI can be used for request information and coordination information.

For example, in this embodiment, the 2nd stage SCI can indicate the target information through at least one information field.

Specifically, a fixed code point of at least one information field in the 2nd SCI indicates the target information, such as indicating that the 2nd SCI is used to transmit request information and/or coordination information; and indicating that the 2nd SCI is used to request preferred resource and/or non-preferred resource.

It should be noted that the 1st SCI is the 1st stage SCI, and the 2nd SCI is the 2nd stage SCI.

The information transmission method in this embodiment of this application can avoid the problem that the excessive number of retransmissions of the request information and/or the coordination information and excessive information result in increased signaling overhead. Furthermore, due to indication for the 2nd SCI to transmit the request information and/or the coordination information, adaptive demodulation is completed.

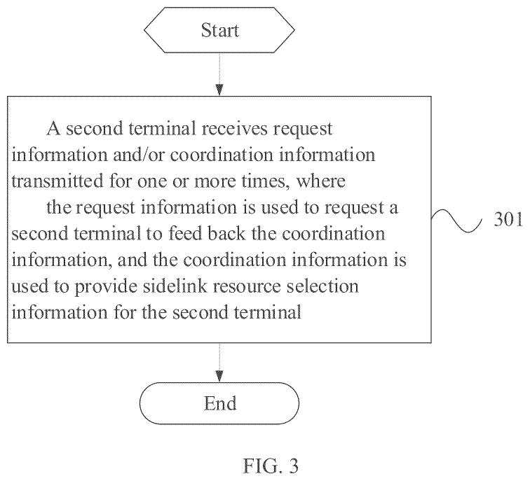

As shown in FIG. 3, an embodiment of this application provides an information transmission method, including the following steps.

Step 301. A second terminal receives request information and/or coordination information transmitted for one or more times.

The request information is used to request the second terminal to feed back the coordination information, and the coordination information is used to provide sidelink resource selection information for the second terminal.

In this way, after receiving the request information sent by the first terminal for one or more times, the second terminal can feed back the coordination information based on the request of the first terminal, so that the first terminal can learn of the SL resource selection information provided by the second terminal for the first terminal and perform resource selection based on the SL resource selection information. The coordination information that is received by the second terminal and that is sent by the first terminal for one or more times can be fed back by the first terminal after the second terminal sends the request information to the first terminal for one or more times, and the second terminal can learn of, based on the received coordination information, the SL resource selection information provided by the first terminal for the second terminal, so that the second terminal can perform resource selection based on the SL resource selection information. In this way, through information transmission between the first terminal and the second terminal, an enhancement scheme for the resource allocation mode is realized.

In some embodiments, after the receiving, by a second terminal, request information and/or coordination information transmitted for one or more times, the method further includes:
sending, by the second terminal, first HARQ-ACK information or second HARQ-ACK information, where
the first HARQ-ACK information is generated by the second terminal based on whether 2nd stage SCI is successfully demodulated, and the 2nd stage SCI carries the request information and/or the coordination information; and
the second HARQ-ACK information is generated by the second terminal based on whether a MAC PDU or a MAC layer data packet is successfully demodulated, and the MAC PDU or the MAC layer data packet includes a MAC CE carrying the request information and/or the coordination information.

In some embodiments, the sending, by the second terminal, first HARQ-ACK information includes:
in a case that the second terminal obtains the request information and/or the coordination information by demodulating the 2nd stage SCI, generating, by the second terminal based on whether the 2nd stage SCI is successfully demodulated, corresponding first HARQ-ACK information, and sending the first HARQ-ACK information.

In some embodiments, the generating, by the second terminal based on whether the 2nd stage SCI is successfully demodulated, corresponding first HARQ-ACK information includes:
generating acknowledgement in a case that the received MAC PDU or MAC layer data packet includes only the MAC CE, and the 2nd stage SCI is successfully demodulated; and
generating negative acknowledgement in a case that the received MAC PDU or MAC layer data packet includes only the MAC CE, and the 2nd stage SCI is not successfully demodulated.

In some embodiments, the sending, by the second terminal, second HARQ-ACK information includes:
in a case that the second terminal obtains the request information and/or the coordination information by demodulating the 2nd stage SCI, and the received MAC PDU or MAC layer data packet includes information other than the MAC CE, generating, by the second terminal based on whether the MAC PDU or the MAC layer data packet is successfully demodulated, corresponding second HARQ-ACK information, and sending the second HARQ-ACK information.

In this case, the first terminal can obtain the second HARQ-ACK information in a case that the second terminal obtains the request information and/or the coordination information by demodulating the 2nd stage SCI, and the received MAC PDU or MAC layer data packet includes information other than the MAC CE carrying the request information and/or the coordination information.

In some embodiments, before the receiving, by a second terminal, request information and/or coordination information transmitted for one or more times, the method further includes:
sending, by the second terminal, second information and/or receiving first information sent by the first terminal, where
the first information is used to indicate whether the first terminal obtains the request information and/or the coordination information by demodulating 2nd stage SCI; and the second information is used to indicate whether the second terminal obtains the request information and/or the coordination information by demodulating the 2nd stage SCI.

It should be noted that this method is implemented in cooperation with the information transmission method executed by the first terminal, and the implementation of the above method embodiment is suitable for this method with a same technical effect.

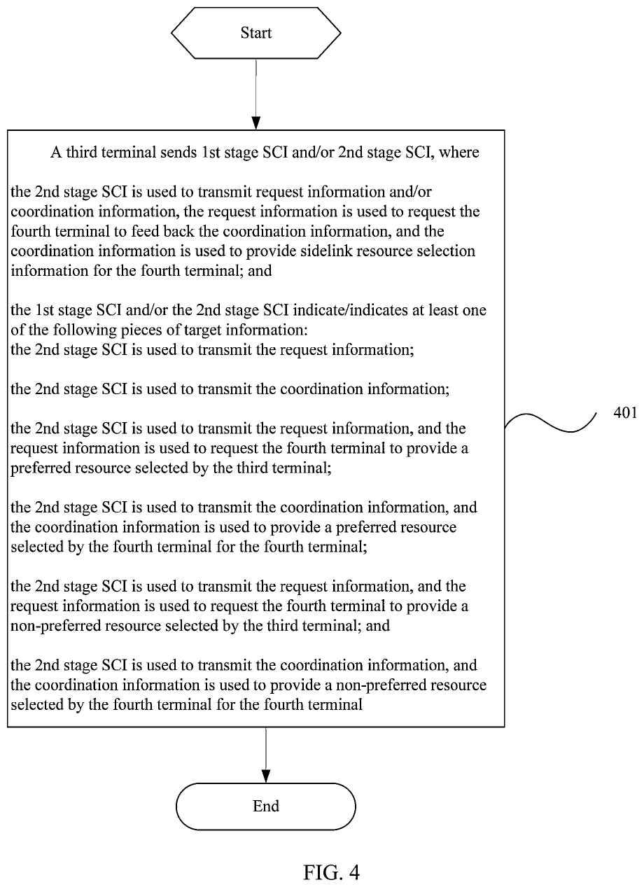

As shown in FIG. 4, an embodiment of this application provides an information transmission indication method, including the following steps.

Step 401. A third terminal sends 1st stage SCI and/or 2nd stage SCI.

The 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

Herein, the third terminal sends 1st stage SCI and/or 2nd stage SCI to the fourth terminal, and transmits request information and/or coordination information through the 2nd stage SCI. The 1st stage SCI and/or the 2nd stage SCI indicate/indicates the target information, so that the fourth terminal can receive the 2nd stage SCI and demodulate the 2nd stage SCI for subsequent processing.

Certainly, the 1st stage SCI and/or the 2nd stage SCI can indicate that the 2nd stage SCI is used to transmit target information of the request information and/or the coordination information. The 2nd stage SCI is used to transmit the request information and/or the coordination information, the request information is used to request the fourth terminal to provide a preferred resource selected by the third terminal, and the coordination information is used to provide target information of a preferred resource selected by the fourth terminal for the fourth terminal. The 2nd stage SCI is used to transmit the request information and/or the coordination information, the request information is used to request the fourth terminal to provide a non-preferred resource selected by the third terminal, and the coordination information is used to provide target information of a non-preferred resource selected by the fourth terminal for the fourth terminal.

It should be noted that in this embodiment, the third terminal may be the first terminal in the information transmission method embodiment, and the fourth terminal may be the second terminal in the information transmission method embodiment. Alternatively, the third terminal may be the second terminal in the information transmission method embodiment, and the fourth terminal may be the first terminal in the information transmission method embodiment.

For example, in this embodiment, the 1st stage SCI indicates the target information through a reserved bit and/or a 2nd SCI format indicator field, and the 2nd stage SCI is associated with the 1st stage SCI.

For example, manner 1: the 2nd SCI format indicator field in the 1st SCI is used to indicate 2nd SCI format 2-C(namely, 2nd SCI used for transmitting the request information), 2nd SCI format 2-D (2nd SCI for transmitting the coordination information). ‘10’ indicates 2nd SCI format 2-C, ‘11’ indicates 2nd SCI format 2-D, and certainly, the reverse is also true.

Manner 2: 2 bits of the reserved bits (such as 2 bits to 4 bits) in the 1st SCI are used to indicate the 2nd SCI format. If the reserved bits are greater than 2 bits, 2 bits are last 2 bits or first 2 bits in the reserved bits. All 0 reservation. ‘00’ indicates SCI that can be sent to a specific terminal for demodulation, ‘01’ indicates that 2nd SCI format can be used to transmit the request information, ‘10’ indicates that the 2nd SCI format can be used to transmit the coordination information, and ‘11’ indicates that the 2nd SCI format can be used to transmit the request information and the coordination information.

Manner 3: 1 bit/2 code points in the 1st SCI indicates/indicate that 2nd SCI format is used for the preferred resource or non-preferred resource. One code point indicates that the 2nd SCI format is used for request information and/or coordination information associated with the preferred resource, and the other code point indicates that the 2nd SCI format is used for request information and/or coordination information associated with the non-preferred resource.

Certainly, in a case that only the 1st stage SCI indicates one or more pieces of the target information, any target information may be indicated by one code point, such as:
one code point indicates that the 2nd stage SCI is used to transmit the request information;
one code point indicates that the 2nd stage SCI is used to transmit the coordination information;
one code point indicates that the 2nd stage SCI is used to transmit the request information and/or the coordination information;
one code point indicates that the 2nd stage SCI is used to transmit the request information, and the request information is used to request the fourth terminal to provide a preferred resource selected by the third terminal;
one code point indicates that the 2nd stage SCI is used to transmit the coordination information, and the coordination information is used to provide a preferred resource selected by the fourth terminal for the fourth terminal;
one code point indicates that the 2nd stage SCI is used to transmit the request information and/or the coordination information, the request information is used to request the fourth terminal to provide a preferred resource selected by the third terminal, and the coordination information is used to provide a preferred resource selected by the fourth terminal for the fourth terminal;
one code point indicates that the 2nd stage SCI is used to transmit the request information, and the request information is used to request the fourth terminal to provide a non-preferred resource selected by the third terminal;
one code point indicates that the 2nd stage SCI is used to transmit the coordination information, and the coordination information is used to provide a non-preferred resource selected by the fourth terminal for the fourth terminal; and
one code point indicates that the 2nd stage SCI is used to transmit the request information and/or the coordination information, the request information is used to request the fourth terminal to provide a non-preferred resource selected by the third terminal, and the coordination information is used to provide a non-preferred resource selected by the fourth terminal for the fourth terminal.

Herein, if some bit(s) in reserved bits (for example, first N bits or last N bits) are used to determine 2nd SCI formats, other bit(s) can be used for other purposes.

For example, in this embodiment, in a case that the 1st stage SCI and the 2nd stage SCI jointly indicate the target information, the 1st stage SCI is associated with the 2nd stage SCI; and
the 1st stage SCI indicates that the 2nd stage SCI is used to transmit any one of the request information and the coordination information, and the 2nd stage SCI indicates the target information through at least one information field.

Herein, the at least one information field may be a specific indicator field dedicated to indicating the target information, or may be a non-specific indicator field of 2nd stage SCI such as resource combination(s) and/or first resource location(s). Certainly, for the non-specific indicator field, the target information can be indicated by special code points of the non-specific indicator field, for example, that the fixed code points in the resource combination(s) and/or the first resource location(s) are all 0 or all 1 indicates that the 2nd stage SCI is used to transmit the request information, and other code points indicate that the 2nd stage SCI is used to transmit the coordination information.

Specifically, that the 1st SCI and the 2nd SCI jointly indicate the target information includes the following manners.

Manner 1: the 2nd SCI format field in the 1st SCI is used to indicate 2nd SCI format 2-C, indicating that 2nd SCI format 2-C can be used to transmit request information and/or coordination information. First 2 bits of the 2nd SCI are used to indicate content carried in the 2nd SCI. For example, ‘00’ indicates that the 2nd SCI can be used to transmit request information, ‘01’ indicates that the 2nd SCI can be used to transmit coordination information, and ‘10’ indicates that 2nd SCI can be used to transmit request information and coordination information.

Manner 2: 1 bit/2 code points in the 1st SCI indicates that the 2nd SCI is used for preferred resource or non-preferred resource. For example, one code point indicates that the 2nd SCI is used to transmit request information and/or coordination information associated with the preferred resource, one code point indicates that the 2nd SCI is used to transmit request information and/or coordination information associated with a non-preferred resource. First 2 bits of the 2nd SCI indicate content carried in the 2nd SCI. For example, ‘00’ indicates that the 2nd SCI can be used to transmit request information, ‘01’ indicates that the 2nd SCI can be used to transmit coordination information, and ‘10’ indicates that 2nd SCI can be used for request information and coordination information.

For example, in this embodiment, the 2nd stage SCI can indicate the target information through at least one information field.

Specifically, a fixed code point of at least one information field in the 2nd SCI indicates the target information, such as indicating that the 2nd SCI is used to transmit request information and/or coordination information; and indicating that the 2nd SCI is used to request preferred resource and/or non-preferred resource.

It should be noted that the 1st SCI is the 1st stage SCI, and the 2nd SCI is the 2nd stage SCI.

In conclusion, the indication for the 2nd SCI that is used to transmitting the request information and/or the coordination information can complete adaptive demodulation processing at a receive end.

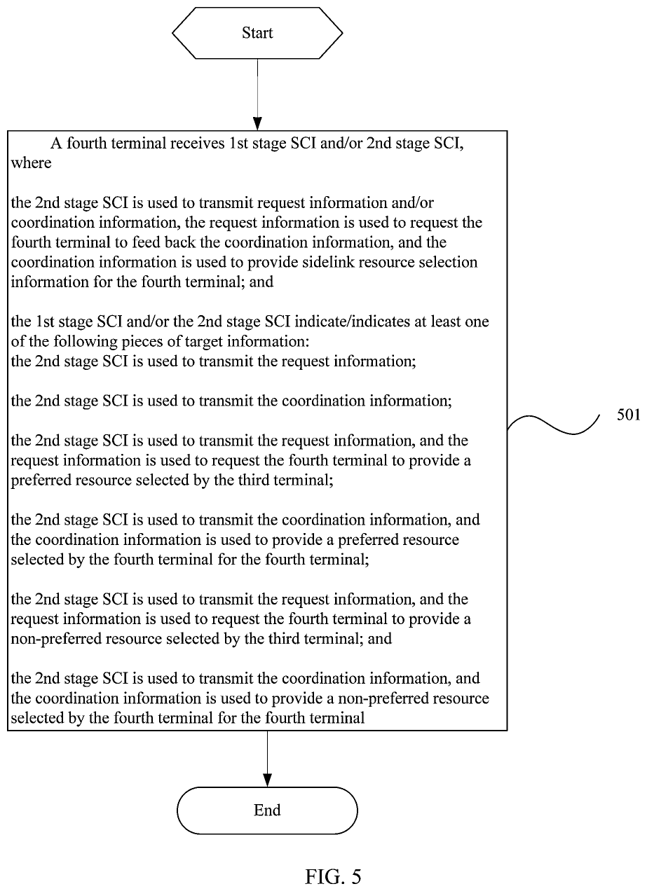

As shown in FIG. 5, an embodiment of this application provides an information transmission indication method, including the following steps.

Step 501. A fourth terminal receives 1st stage SCI and/or 2nd stage SCI.

The 2nd stage SCI is used to transmit request information and/or coordination information, the request information is used to request the fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

Herein, the fourth terminal receives 1st stage SCI and/or 2nd stage SCI sent by the third terminal, and transmits request information and/or coordination information through the 2nd stage SCI. The 1st stage SCI and/or the 2nd stage SCI indicate/indicates the target information, so that demodulation is completed after receiving the 2nd stage SCI for subsequent processing.

Certainly, the 1st stage SCI and/or the 2nd stage SCI can indicate that the 2nd stage SCI is used to transmit target information of the request information and/or the coordination information. The 2nd stage SCI is used to transmit the request information and/or the coordination information, the request information is used to request the fourth terminal to provide a preferred resource selected by the third terminal, and the coordination information is used to provide target information of a preferred resource selected by the fourth terminal for the fourth terminal. The 2nd stage SCI is used to transmit the request information and/or the coordination information, the request information is used to request the fourth terminal to provide a non-preferred resource selected by the third terminal, and the coordination information is used to provide target information of a non-preferred resource selected by the fourth terminal for the fourth terminal.

In some embodiments, the 1st stage SCI indicates the target information through a reserved bit and/or a 2nd SCI format indicator field, and the 2nd stage SCI is associated with the 1st stage SCI.

In some embodiments, in a case that the 1st stage SCI and the 2nd stage SCI jointly indicate the target information, the 1st stage SCI is associated with the 2nd stage SCI; and
the 1st stage SCI indicates that the 2nd stage SCI is used to transmit any one of the request information and the coordination information, and the 2nd stage SCI indicates the target information through at least one information field.

It should be noted that this method is implemented in cooperation with the information transmission indication method executed by the third terminal, and the implementation of the above method embodiment is suitable for this method with a same technical effect.

The information transmission method provided in this embodiment of this application may be executed by an information transmission apparatus. In this embodiment of this application, that the information transmission apparatus performs the information transmission method is used as an example to describe the information transmission apparatus provided in this embodiment of this application.

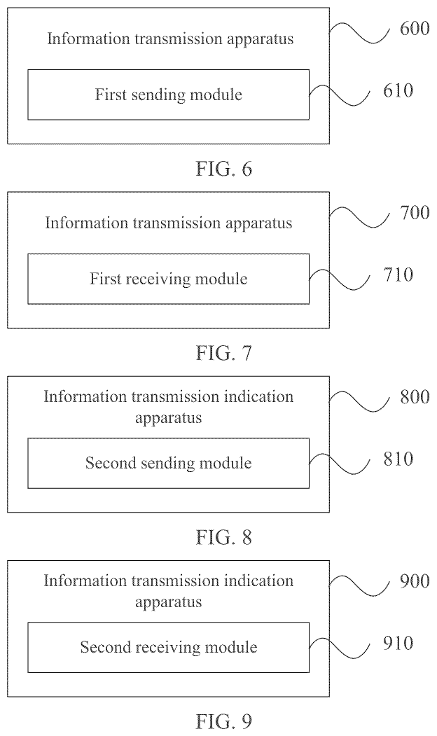

As shown in FIG. 6, an embodiment of this application provides an information transmission apparatus 600, including:
a first sending module 610, configured to transmit request information and/or coordination information for one or more times, where
the request information is used to request a second terminal to feed back the coordination information, and the coordination information is used to provide sidelink resource selection information for the second terminal.

In some embodiments, the first sending module is further configured to:
transmit the request information and/or the coordination information for one or more times based on a preset number of retransmissions.

In some embodiments, the apparatus further includes:
a determining module, configured to determine, based on received first HARQ-ACK information or second HARQ-ACK information, whether to retransmit the request information and/or the coordination information, where
the first HARQ-ACK information is generated by the second terminal based on whether 2nd stage SCI is successfully demodulated, and the 2nd stage SCI carries the request information and/or the coordination information; and
the second HARQ-ACK information is generated by the second terminal based on whether an MAC PDU or a MAC layer data packet is successfully demodulated, and the MAC PDU or the MAC layer data packet includes an MAC CE carrying the request information and/or the coordination information.

In some embodiments, the determining module is further configured to:
in a case that the received first HARQ-ACK information is negative acknowledgement, retransmit the request information and/or the coordination information; or
in a case that the first HARQ-ACK information is not received, retransmit the request information and/or the coordination information; or
in a case that the received first HARQ-ACK information is acknowledgement, stop transmitting the request information and/or the coordination information.

In some embodiments, the determining module is further configured to:
in a case that the received second HARQ-ACK information is negative acknowledgement, retransmit the request information and/or the coordination information; or
in a case that the second HARQ-ACK information is not received, retransmit the request information and/or the coordination information; or
in a case that the received second HARQ-ACK information is acknowledgement, stop transmitting the request information and/or the coordination information.

In some embodiments, the determining module is further configured to:
in a case that the received second HARQ-ACK information is negative acknowledgement or acknowledgement, stop transmitting the request information and/or the coordination information; or
in a case that the second HARQ-ACK information is not received, retransmit the request information and/or the coordination information.

In some embodiments, the determining module is further configured to:
in a case that the MAC PDU or the MAC layer data packet includes only the MAC CE, determine, based on the first HARQ-ACK information, whether to retransmit the request information and/or the coordination information; and
in a case that the MAC PDU or the MAC layer data packet includes information other than the MAC CE, determine, based on the second HARQ-ACK information, whether to retransmit the request information and/or the coordination information.

In some embodiments, the apparatus further includes:
a processing module, configured to determine whether the MAC PDU or the MAC layer data packet includes information other than the MAC CE; and
the determining module is further configured to:
in a case that the MAC PDU or the MAC layer data packet includes information other than the MAC CE, and the second HARQ-ACK information is negative acknowledgement, retransmit the request information and/or the coordination information;
in a case that the MAC PDU or the MAC layer data packet includes information other than the MAC CE, and the second HARQ-ACK information is acknowledgement, stop transmitting the request information and/or the coordination information; and
in a case that the MAC PDU or the MAC layer data packet includes only the MAC CE, and the second HARQ-ACK information is negative acknowledgement or acknowledgement, stop transmitting the request information and/or the coordination information.

In some embodiments, the apparatus further includes:
a first interaction module, configured to send first information and/or receive second information sent by the second terminal, where
the first information is used to indicate whether the first terminal obtains the request information and/or the coordination information by demodulating 2nd stage SCI; and the second information is used to indicate whether the second terminal obtains the request information and/or the coordination information by demodulating the 2nd stage SCI.

In some embodiments, the first sending module is further configured to retransmit the request information and/or the coordination information in a preset manner, where
the preset manner includes at least one of the following:
blind retransmission; and
retransmission based on received first HARQ-ACK information or second HARQ-ACK information.

In some embodiments, a first information field of the coordination information indicates resource selection information, where the resource selection information includes a target transmission resource that is preferred/non-preferred to be selected by the second terminal; and
a time-frequency resource indicated by the first information field or a time-domain resource in which the time-frequency resource indicated by the first information field is located is the target transmission resource that is preferred/non-preferred to be selected by the second terminal.

The apparatus sends the request information to the second terminal one or more times, requesting the second terminal to feed back the coordination information, so as to learn of the SL resource selection information provided by the second terminal for the first terminal and perform resource selection based on the SL resource selection information. After receiving the request information sent by the second terminal, the apparatus can also provide SL resource selection information for the second terminal by feeding back the coordination information to the second terminal for one or more times, so that the second terminal can perform resource selection based on the SL resource selection information. In this way, through information transmission with the second terminal, an enhancement scheme for the resource allocation mode is realized.

It should be noted that this apparatus is an apparatus to which the information transmission method executed by the first terminal is applied, and the implementation of the above method embodiment is suitable for this apparatus with a same technical effect.

As shown in FIG. 7, an embodiment of this application provides an information transmission apparatus 700, including:
a first receiving module 710, configured to receive request information and/or coordination information transmitted for one or more times, where
the request information is used to request a second terminal to feed back the coordination information, and the coordination information is used to provide sidelink resource selection information for the second terminal.

In some embodiments, the apparatus further includes:
an HARQ-ACK information feedback module, configured to send first HARQ-ACK information or second HARQ-ACK information, where
the first HARQ-ACK information is generated by the second terminal based on whether 2nd stage SCI is successfully demodulated, and the 2nd stage SCI carries the request information and/or the coordination information; and
the second HARQ-ACK information is generated by the second terminal based on whether a MAC PDU or a MAC layer data packet is successfully demodulated, and the MAC PDU or the MAC layer data packet includes a MAC CE carrying the request information and/or the coordination information.

In some embodiments, the HARQ-ACK information feedback module is further configured to:
in a case that the second terminal obtains the request information and/or the coordination information by demodulating the 2nd stage SCI, generate, based on whether the 2nd stage SCI is successfully demodulated, corresponding first HARQ-ACK information, and send the first HARQ-ACK information.

In some embodiments, the HARQ-ACK information feedback module is further configured to:
generate acknowledgement in a case that the received MAC PDU or MAC layer data packet includes only the MAC CE, and the 2nd stage SCI is successfully demodulated; and
generate negative acknowledgement in a case that the received MAC PDU or MAC layer data packet includes only the MAC CE, and the 2nd stage SCI is not successfully demodulated.

In some embodiments, the HARQ-ACK information feedback module is further configured to:
in a case that the second terminal obtains the request information and/or the coordination information by demodulating the 2nd stage SCI, and the received MAC PDU or MAC layer data packet includes information other than the MAC CE, generate, based on whether the MAC PDU or the MAC layer data packet is successfully demodulated, corresponding second HARQ-ACK information, and send the second HARQ-ACK information.

In some embodiments, the apparatus further includes:
a second interaction module, configured to send second information and/or receive first information sent by the first terminal, where
the first information is used to indicate whether the first terminal obtains the request information and/or the coordination information by demodulating 2nd stage SCI; and the second information is used to indicate whether the second terminal obtains the request information and/or the coordination information by demodulating the 2nd stage SCI.

After receiving the request information sent by the first terminal for one or more times, the apparatus can feed back the coordination information based on the request of the first terminal, so that the first terminal can learn of the SL resource selection information provided for the first terminal and perform resource selection based on the SL resource selection information. The coordination information that is received by the apparatus and that is sent by the first terminal for one or more times can be fed back by the first terminal after receiving the request information sent to the first terminal for one or more times, and the apparatus can learn of, based on the received coordination information, the SL resource selection information provided by the first terminal for the apparatus, so that the apparatus can perform resource selection based on the SL resource selection information. In this way, through information transmission with the first terminal, an enhancement scheme for the resource allocation mode is realized.

It should be noted that this apparatus is an apparatus to which the information transmission method executed by the second terminal is applied, and the implementation of the above method embodiment is suitable for this apparatus with a same technical effect.

As shown in FIG. 8, an embodiment of this application provides an information transmission indication apparatus 800, including:
a second sending module 810, configured to send 1st stage SCI and/or 2nd stage SCI, where
the 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

In some embodiments, the 1st stage SCI indicates the target information through a reserved bit and/or a 2nd SCI format indicator field, and the 2nd stage SCI is associated with the 1 st stage SCI.

In some embodiments, in a case that the 1st stage SCI and the 2nd stage SCI jointly indicate the target information, the 1st stage SCI is associated with the 2nd stage SCI; and
the 1st stage SCI indicates that the 2nd stage SCI is used to transmit any one of the request information and the coordination information, and the 2nd stage SCI indicates the target information through at least one information field.

The apparatus sends 1st stage SCI and/or 2nd stage SCI to the fourth terminal, and transmits request information and/or coordination information through the 2nd stage SCI. The 1st stage SCI and/or the 2nd stage SCI indicate/indicates the target information, so that the fourth terminal can receive the 2nd stage SCI and demodulate the 2nd stage SCI for subsequent processing.

It should be noted that this apparatus implements the information transmission indication method executed by the third terminal, and the implementation of the above method embodiment is suitable for this apparatus with a same technical effect.

As shown in FIG. 9, an embodiment of this application provides an information transmission indication apparatus 900, including:
a second receiving module 910, configured to receive 1st stage SCI and/or 2nd stage SCI, where
the 2nd stage SCI is used to transmit request information and/or coordination information, the request information is used to request a fourth terminal to feed back the coordination information, and the coordination information is used to provide sidelink resource selection information for the fourth terminal; and
the 1st stage SCI and/or the 2nd stage SCI indicate/indicates at least one of the following pieces of target information:
the 2nd stage SCI is used to transmit the request information;
the 2nd stage SCI is used to transmit the coordination information;
the 2nd stage SCI is used to transmit the request information, and the request information is used to request the fourth terminal to provide a preferred resource selected by the third terminal;
the 2nd stage SCI is used to transmit the coordination information, and the coordination information is used to provide a preferred resource selected by the fourth terminal for the fourth terminal;
the 2nd stage SCI is used to transmit the request information, and the request information is used to request the fourth terminal to provide a non-preferred resource selected by the third terminal; and
the 2nd stage SCI is used to transmit the coordination information, and the coordination information is used to provide a non-preferred resource selected by the fourth terminal for the fourth terminal.

In some embodiments, the 1st stage SCI indicates the target information through a reserved bit and/or a 2nd SCI format indicator field, and the 2nd stage SCI is associated with the 1 st stage SCI.

In some embodiments, in a case that the 1st stage SCI and the 2nd stage SCI jointly indicate the target information, the 1st stage SCI is associated with the 2nd stage SCI; and
the 1st stage SCI indicates that the 2nd stage SCI is used to transmit any one of the request information and the coordination information, and the 2nd stage SCI indicates the target information through at least one information field.

The apparatus receives 1st stage SCI and/or 2nd stage SCI sent by the third terminal, and transmits request information and/or coordination information through the 2nd stage SCI. The 1st stage SCI and/or the 2nd stage SCI indicate/indicates the target information, so that demodulation is completed after receiving the 2nd stage SCI for subsequent processing.

It should be noted that this apparatus implements the information transmission indication method executed by the fourth terminal, and the implementation of the above method embodiment is suitable for this apparatus with a same technical effect.

The apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), and the like. This is not specifically limited in this embodiment of this application.

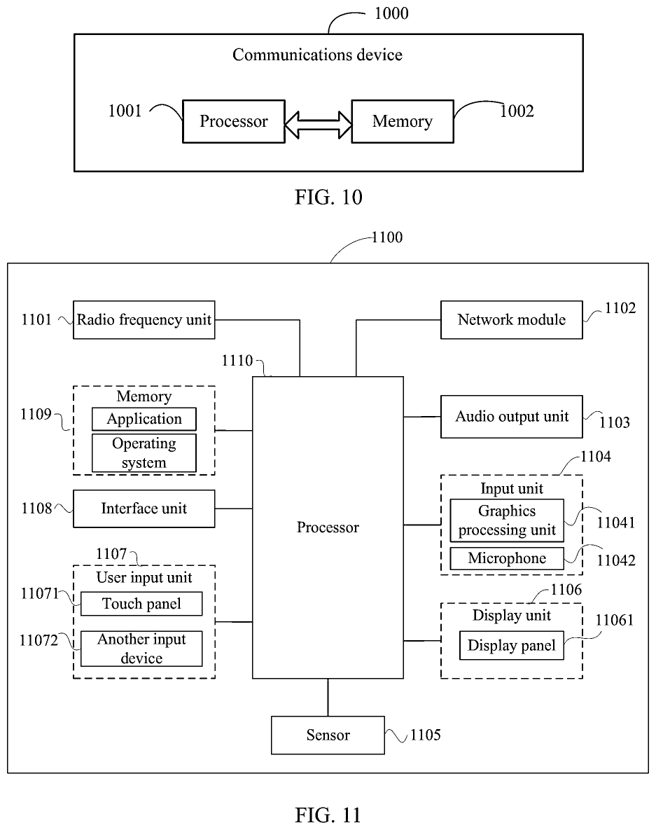

For example, as shown in FIG. 10, an embodiment of this application further provides a communications device 1000, including a processor 1001 and a memory 1002. The memory 1002 stores a program or an instruction that can be run on the processor 1001. For example, in a case that the communications device 1000 is a terminal, when the program or the instruction is executed by the processor 1001, steps of the embodiment of the information transmission method implemented by the first terminal are implemented, steps of the embodiment of the information transmission method implemented by the second terminal are implemented, steps of the embodiment of the information transmission indication method implemented by the third terminal are implemented, or steps of the embodiment of the information transmission indication method implemented by the fourth terminal are implemented, and a same technical effect can be achieved. To avoid repetition, details are not described herein again.

An embodiment of this application further provides a terminal, including a processor and a communications interface, and the communications interface is configured to transmit request information and/or coordination information for one or more times, where the request information is used to request a second terminal to feed back the coordination information, and the coordination information is used to provide sidelink resource selection information for the second terminal. The terminal embodiment is corresponding to the first terminal side method embodiment, each implementation process and implementation of the method embodiment can be applied to the terminal embodiment, and a same technical effect can be achieved. Specifically, FIG. 11 is a schematic diagram of a hardware structure of a terminal according to an embodiment of this application.

A terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 1104 may include a Graphics Processing Unit (GPU) 11041 and a microphone 11042. The graphics processing unit 11041 processes image data of a static picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 1109 in this embodiment of this application includes but is not limited to these memories and any memory of another proper type.

The processor 1110 may include one or more processing units. In some embodiments, an application processor and a modem processor are integrated into the processor 1110. The application processor mainly processes an operating system, a user interface, an application, or the like. The modem processor mainly processes a wireless communication signal, for example, a baseband processor. It may be understood that, alternatively, the modem processor may not be integrated into the processor 1110.

The radio frequency unit 1101 is configured to transmit request information and/or coordination information for one or more times, where
the request information is used to request a second terminal to feed back the coordination information, and the coordination information is used to provide sidelink resource selection information for the second terminal.

In some embodiments, the radio frequency unit 1101 is further configured to transmit the request information and/or the coordination information for one or more times based on a preset number of retransmissions.

In some embodiments, the processor 1110 is configured to determine, based on received first HARQ-ACK information or second HARQ-ACK information, whether to retransmit the request information and/or the coordination information, where
the first HARQ-ACK information is generated by the second terminal based on whether 2nd stage SCI is successfully demodulated, and the 2nd stage SCI carries the request information and/or the coordination information; and
the second HARQ-ACK information is generated by the second terminal based on whether an MAC PDU or a MAC layer data packet is successfully demodulated, and the MAC PDU or the MAC layer data packet includes an MAC CE carrying the request information and/or the coordination information.

In some embodiments, the processor 1110 is further configured to: in a case that the received first HARQ-ACK information is negative acknowledgement, retransmit the request information and/or the coordination information; or
in a case that the first HARQ-ACK information is not received, retransmit the request information and/or the coordination information; or
in a case that the received first HARQ-ACK information is acknowledgement, stop transmitting the request information and/or the coordination information.

In some embodiments, the processor 1110 is further configured to: in a case that the received second HARQ-ACK information is negative acknowledgement, retransmit the request information and/or the coordination information; or
in a case that the second HARQ-ACK information is not received, retransmit the request information and/or the coordination information; or
in a case that the received second HARQ-ACK information is acknowledgement, stop transmitting the request information and/or the coordination information.

In some embodiments, the processor 1110 is further configured to:
in a case that the received second HARQ-ACK information is negative acknowledgement or acknowledgement, stop transmitting the request information and/or the coordination information; or
in a case that the second HARQ-ACK information is not received, retransmit the request information and/or the coordination information.

In some embodiments, the processor 1110 is further configured to:
in a case that the MAC PDU or the MAC layer data packet includes only the MAC CE, determine, based on the first HARQ-ACK information, whether to retransmit the request information and/or the coordination information; and
in a case that the MAC PDU or the MAC layer data packet includes information other than the MAC CE, determine, based on the second HARQ-ACK information, whether to retransmit the request information and/or the coordination information.

In some embodiments, the processor 1110 is further configured to:
determine whether the MAC PDU or the MAC layer data packet includes information other than the MAC CE;
in a case that the MAC PDU or the MAC layer data packet includes information other than the MAC CE, and the second HARQ-ACK information is negative acknowledgement, retransmit the request information and/or the coordination information;
in a case that the MAC PDU or the MAC layer data packet includes information other than the MAC CE, and the second HARQ-ACK information is acknowledgement, stop transmitting the request information and/or the coordination information; and
in a case that the MAC PDU or the MAC layer data packet includes only the MAC CE, and the second HARQ-ACK information is negative acknowledgement or acknowledgement, stop transmitting the request information and/or the coordination information.

In some embodiments, the radio frequency unit 1101 is further configured to:
send first information and/or receive second information sent by the second terminal, where
the first information is used to indicate whether the first terminal obtains the request information and/or the coordination information by demodulating 2nd stage SCI; and the second information is used to indicate whether the second terminal obtains the request information and/or the coordination information by demodulating the 2nd stage SCI.

In some embodiments, the radio frequency unit 1101 is further configured to:
retransmit the request information and/or the coordination information in a preset manner, where
the preset manner includes at least one of the following:
blind retransmission; and
retransmission based on received first HARQ-ACK information or second HARQ-ACK information.

In some embodiments, a first information field of the coordination information indicates resource selection information, where the resource selection information includes a target transmission resource that is preferred/non-preferred to be selected by the second terminal; and
a time-frequency resource indicated by the first information field or a time-domain resource in which the time-frequency resource indicated by the first information field is located is the target transmission resource that is preferred/non-preferred to be selected by the second terminal.

As the first terminal, the terminal sends the request information to the second terminal one or more times, requesting the second terminal to feed back the coordination information, so as to learn of the SL resource selection information provided by the second terminal for the first terminal and perform resource selection based on the SL resource selection information. After receiving the request information sent by the second terminal, the terminal can also provide SL resource selection information for the second terminal by feeding back the coordination information to the second terminal for one or more times, so that the second terminal can perform resource selection based on the SL resource selection information. In this way, through information transmission with the second terminal, an enhancement scheme for the resource allocation mode is realized.

It should also be noted that the terminal shown in FIG. 11 can also be used as the second terminal, the third terminal, or the fourth terminal to realize the corresponding method, and details are not described herein again.

An embodiment of this application further provides a readable storage medium. The readable storage medium stores a program or an instruction, and when the program or the instruction is executed by a processor, processes of the embodiment of the information transmission method implemented by the first terminal are implemented, processes of the embodiment of the information transmission method implemented by the second terminal are implemented, processes of the embodiment of the information transmission indication method implemented by the third terminal are implemented, or processes of the embodiment of the information transmission indication method implemented by the fourth terminal are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip, the chip includes a processor and a communications interface, the communications interface is coupled to the processor, and the processor is configured to run a program or an instruction to implement processes of the embodiment of the information transmission method implemented by the first terminal, processes of the embodiment of the information transmission method implemented by the second terminal, processes of the embodiment of the information transmission indication method implemented by the third terminal, or processes of the embodiment of the information transmission indication method implemented by the fourth terminal, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement processes of the embodiment of the information transmission method implemented by the first terminal, processes of the embodiment of the information transmission method implemented by the second terminal, processes of the embodiment of the information transmission indication method implemented by the third terminal, or processes of the embodiment of the information transmission indication method implemented by the fourth terminal, and a same technical effect can be achieved. To avoid repetition, details are not described herein again.

An embodiment of this application further provides a communications system, including a terminal and a network side device, where the terminal may be configured to perform steps of the information transmission method implemented by the first terminal, steps of the information transmission method implemented by the second terminal, steps of the information transmission indication method implemented by the third terminal, or steps of the information transmission indication method implemented by the fourth terminal.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information transmission method, comprising:
transmitting, by a first terminal, request information or coordination information for one or more times, wherein
the request information is used to request a second terminal to feed back the coordination information, and the coordination information is used to provide sidelink resource selection information for the second terminal.

2. The information transmission method according to claim 1, wherein transmitting, by the first terminal, the request information or the coordination information for one or more times comprises:
transmitting, by the first terminal, the request information or the coordination information for one or more times based on a preset number of retransmissions.

3. The information transmission method according to claim 1, wherein before transmitting, by the first terminal, the request information or the coordination information for one or more times, the method further comprises:
determining, by the first terminal based on received first Hybrid Automatic Repeat reQuest ACKnowledgement (HARQ-ACK) information or second HARQ-ACK information, whether to retransmit the request information or the coordination information, wherein
the first HARQ-ACK information is generated by the second terminal based on whether 2nd stage Sidelink Control Information (SCI) is successfully demodulated, and the 2nd stage SCI carries the request information or the coordination information, and
the second HARQ-ACK information is generated by the second terminal based on whether a Media Access Control Protocol Data Unit (MAC PDU) or a MAC layer data packet is successfully demodulated, and the MAC PDU or the MAC layer data packet comprises an MAC Control Element (CE) carrying the request information or the coordination information.

4. The information transmission method according to claim 3, wherein determining, by the first terminal, whether to retransmit the request information or the coordination information based on the first HARQ-ACK information comprises:
when the received first HARQ-ACK information is negative acknowledgement, retransmitting, by the first terminal, the request information or the coordination information, or
when the first HARQ-ACK information is not received, retransmitting, by the first terminal, the request information or the coordination information, or
when the received first HARQ-ACK information is acknowledgement, stopping transmitting, by the first terminal, the request information or the coordination information.

5. The information transmission method according to claim 3, wherein determining, by the first terminal based on the second HARQ-ACK information, whether to retransmit the request information or the coordination information comprises:
when the received second HARQ-ACK information is negative acknowledgement, retransmitting, by the first terminal, the request information or the coordination information, or
when the second HARQ-ACK information is not received, retransmitting, by the first terminal, the request information or the coordination information, or
when the received second HARQ-ACK information is acknowledgement, stopping transmitting, by the first terminal, the request information or the coordination information.

6. The information transmission method according to claim 3, wherein determining, by the first terminal based on the second HARQ-ACK information, whether to retransmit the request information or the coordination information comprises:
when the received second HARQ-ACK information is negative acknowledgement or acknowledgement, stopping transmitting, by the first terminal, the request information or the coordination information, or
when the second HARQ-ACK information is not received, retransmitting, by the first terminal, the request information or the coordination information.

7. The information transmission method according to claim 3, wherein determining, by the first terminal, whether to retransmit the request information or the coordination information based on received first HARQ-ACK information or second HARQ-ACK information comprises at least one of the following:
when the MAC PDU or the MAC layer data packet comprises only the MAC CE, determining, by the first terminal based on the first HARQ-ACK information, whether to retransmit the request information or the coordination information, or
when the MAC PDU or the MAC layer data packet comprises information other than the MAC CE, determining, by the first terminal based on the second HARQ-ACK information, whether to retransmit the request information or the coordination information.

8. The information transmission method according to claim 3, wherein before determining, by the first terminal based on the second HARQ-ACK information, whether to retransmit the request information or the coordination information, the method further comprises:
determining, by the first terminal, whether the MAC PDU or the MAC layer data packet comprises information other than the MAC CE, and
determining, by the first terminal based on the second HARQ-ACK information, whether to retransmit the request information or the coordination information comprises:
when the MAC PDU or the MAC layer data packet comprises information other than the MAC CE, and the second HARQ-ACK information is negative acknowledgement, retransmitting, by the first terminal, the request information or the coordination information,
when the MAC PDU or the MAC layer data packet comprises information other than the MAC CE, and the second HARQ-ACK information is acknowledgement, stopping transmitting, by the first terminal, the request information or the coordination information, and
when the MAC PDU or the MAC layer data packet comprises only the MAC CE, and the second HARQ-ACK information is negative acknowledgement or acknowledgement, stopping transmitting, by the first terminal, the request information or the coordination information.

9. The information transmission method according to claim 1, wherein before transmitting, by a first terminal, the request information or the coordination information for one or more times, the method further comprises:
sending, by the first terminal, first information or receiving second information sent by the second terminal, wherein
the first information is used to indicate whether the first terminal obtains the request information or the coordination information by demodulating 2nd stage SCI, and the second information is used to indicate whether the second terminal obtains the request information or the coordination information by demodulating the 2nd stage SCI.

10. The information transmission method according to claim 1, wherein transmitting, by the first terminal, the request information or the coordination information for more than one time comprises:
retransmitting, by the first terminal, the request information or the coordination information in a preset manner, wherein
the preset manner comprises at least one of the following:
blind retransmission, or
retransmission based on received first HARQ-ACK information or second HARQ-ACK information.

11. The information transmission method according to claim 3, wherein a first information field of the coordination information indicates resource selection information, wherein the resource selection information comprises a target transmission resource that is preferred/non-preferred to be selected by the second terminal; and
a time-frequency resource indicated by the first information field or a time-domain resource in which the time-frequency resource indicated by the first information field is located is the target transmission resource that is preferred/non-preferred to be selected by the second terminal.

12. The information transmission method according to claim 1, wherein transmitting, by the first terminal, the request information or the coordination information for one or more times comprises:
sending, by the first terminal, 1st stage SCI or 2nd stage SCI, wherein the 2nd stage SCI is used to transmit request information or coordination information, and the 1st stage SCI or the 2nd stage SCI indicates at least one of the following pieces of target information:
the 2nd stage SCI is used to transmit the request information, or
the 2nd stage SCI is used to transmit the coordination information.

13. A first terminal, comprising: a processor; and a memory having a computer program or an instruction stored thereon, wherein the computer program or the instruction, when executed by the processor, causes the processor to perform operations, comprising:
transmitting request information or coordination information for one or more times,
wherein the request information is used to request a second terminal to feed back the coordination information, and the coordination information is used to provide sidelink resource selection information for the second terminal.

14. The first terminal according to claim 13, wherein transmitting the request information or the coordination information for one or more times comprises:
transmitting the request information or the coordination information for one or more times based on a preset number of retransmissions.

15. The first terminal according to claim 13, wherein before transmitting the request information or the coordination information for one or more times, the operations further comprise:
determining based on received first Hybrid Automatic Repeat reQuest ACKnowledgement (HARQ-ACK) information or second HARQ-ACK information, whether to retransmit the request information or the coordination information, wherein
the first HARQ-ACK information is generated by the second terminal based on whether 2nd stage Sidelink Control Information (SCI) is successfully demodulated, and the 2nd stage SCI carries the request information or the coordination information, and
the second HARQ-ACK information is generated by the second terminal based on whether a Media Access Control Protocol Data Unit (MAC PDU) or a MAC layer data packet is successfully demodulated, and the MAC PDU or the MAC layer data packet comprises an MAC Control Element (CE) carrying the request information or the coordination information.

16. The first terminal according to claim 15, wherein determining whether to retransmit the request information or the coordination information based on the first HARQ-ACK information comprises:
when the received first HARQ-ACK information is negative acknowledgement, retransmitting the request information or the coordination information, or
when the first HARQ-ACK information is not received, retransmitting the request information or the coordination information, or
when the received first HARQ-ACK information is acknowledgement, stopping transmitting the request information or the coordination information.

17. The first terminal according to claim 15, wherein determining based on the second HARQ-ACK information, whether to retransmit the request information or the coordination information comprises:
when the received second HARQ-ACK information is negative acknowledgement, retransmitting the request information or the coordination information, or
when the second HARQ-ACK information is not received, retransmitting the request information or the coordination information, or
when the received second HARQ-ACK information is acknowledgement, stopping transmitting the request information or the coordination information.

18. The first terminal according to claim 15, wherein determining based on the second HARQ-ACK information, whether to retransmit the request information or the coordination information comprises:
when the received second HARQ-ACK information is negative acknowledgement or acknowledgement, stopping transmitting the request information or the coordination information, or
when the second HARQ-ACK information is not received, retransmitting the request information or the coordination information.

19. The first terminal according to claim 15, wherein determining whether to retransmit the request information or the coordination information based on received first HARQ-ACK information or second HARQ-ACK information comprises at least one of the following:
when the MAC PDU or the MAC layer data packet comprises only the MAC CE, determining based on the first HARQ-ACK information, whether to retransmit the request information or the coordination information, or
when the MAC PDU or the MAC layer data packet comprises information other than the MAC CE, determining based on the second HARQ-ACK information, whether to retransmit the request information or the coordination information.

20. A non-transitory computer-readable storage medium storing a computer program or an instruction that, when executed by a processor, causes the processor to perform operations, comprising:
transmitting, by a first terminal, request information or coordination information for one or more times, wherein
the request information is used to request a second terminal to feed back the coordination information, and the coordination information is used to provide sidelink resource selection information for the second terminal.
